(19) United States
(12) Patent Application Publication
(10) Pub. No.: US 2023/0324558 A1
(43) Pub. Date: Oct. 12, 2023

(54) SENSOR FIELD-OF-VIEW MANIPULATION

(71) Applicant: FARO Technologies, Inc., Lake Mary, FL (US)

(72) Inventor: Mufassar Waheed, Ditzingen (DE)

(21) Appl. No.: 18/131,330

(22) Filed: Apr. 5, 2023

Related U.S. Application Data
(60) Provisional application No. 63/327,903, filed on Apr. 6, 2022.

(51) Int. Cl. G01S 17/894; G01S 7/481

(52) U.S. Cl. CPC G01S 17/894; G01S 7/4817

(57) ABSTRACT

A mobile 3D measuring system includes a 3D measuring device comprising a sensor that emits a plurality of scan lines in a field of view of the sensor. The 3D system further includes a field of view manipulator coupled with the 3D measuring device, the field of view manipulator comprising a passive optic element that redirects a first scan line from the plurality of scan lines. The 3D system further includes a computing system coupled with the 3D measuring device. The 3D measuring device continuously transmits a captured data from the sensor to the computing system as the 3D measuring device is moved in an environment, the captured data is based on receiving reflections corresponding to the plurality of scan lines, including a reflection of the first scan line that is redirected. The computing system generates a 3D point cloud representing the environment based on the captured data.

### CROSS-REFERENCE TO RELATED APPLICATIONS

The present application claims the benefit of, and priority to, U.S. Provisional Application Ser. No. 63/327,903 filed on Apr. 6, 2022, the contents of which are incorporated herein by reference.

### BACKGROUND

The present disclosure relates to a system and method which can facilitate measuring, capturing, and storing a three-dimensional (3D) representation of a surrounding environment, and particularly to manipulating field-of-view (FOV) of sensors, such as lidars, with optical systems.

The subject matter disclosed herein relates particularly to a 3D laser scanner time-of-flight (TOF) coordinate measurement device. A 3D laser scanner of this type steers a beam of light to a non-cooperative target, such as a diffusely scattering surface of an object. A distance meter in the device measures a distance to the object, and angular encoders measure the angles of the emitted light. The measured distance and angles enable a processor in the device to determine the 3D coordinates of the target.

A TOF laser scanner (or simply TOF scanner) is a scanner in which the distance to a target point is determined based on the speed of light in the air between the scanner and a target point. Laser scanners are typically used for scanning closed or open spaces such as interior areas of buildings, industrial installations, and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., azimuth and a zenith angle), and optionally a gray-scale value. This raw scan data is collected, stored, and sent to a processor or processors to generate a 3D image representing the scanned area or object.

Generating an image requires at least three values for each data point. These three values may include the distance and two angles or may be transformed values, such as the x, y, z coordinates. In an embodiment, an image is also based on a fourth gray-scale value, which is a value related to the irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the digital camera images to an operator of the laser scanner. By viewing the camera images, the operator of the scanner can determine the field of view of the measured volume and adjust settings on the laser scanner to measure over a larger or smaller region of space. In addition, the camera's digital images may be transmitted to a processor to add color to the scanner image. To generate a color scanner image, at least three positional coordinates (such as x, y, z) and three color values (such as red, green, blue “RGB”) are collected for each data point.

A 3D image of a scene may require multiple scans from different registration stationary positions. The overlapping scans are registered in a joint coordinate system, for example, as described in U.S. Published Patent Application No. 2012/0069352 ('352), the contents of which are incorporated herein by reference. Such registration is performed by matching targets in overlapping regions of the multiple scans. The targets may be artificial targets such as spheres or checkerboards, or they may be natural features such as corners or edges of walls. Some registration procedures involve relatively time-consuming manual procedures such as identifying by a user each target and matching the targets obtained by the scanner in each of the different registration positions. Some registration procedures also require establishing an external “control network” of registration targets measured by an external device such as a total station. The registration method disclosed in '352 eliminates the need for user matching of registration targets and establishing a control network.

A TOF laser scanner is usually mounted on a tripod or instrument stand while measuring the 3D coordinates of its surroundings. An operator is required to move the tripod from location to location as measurements are taken. In many cases, post-processing is required to properly register the 3D coordinate data. The operational and post-processing steps can be time-consuming.

Accordingly, while existing 3D scanners are suitable for their intended purposes, there is a need for apparatus and methods providing greater efficiency in 3D measurement according to certain features of embodiments of the present invention.

### BRIEF DESCRIPTION

A mobile three-dimensional (3D) measuring system, includes a 3D measuring device comprising a sensor that emits a plurality of scan lines in a field of view of the sensor. The 3D measuring system further includes a field of view manipulator coupled with the 3D measuring device, the field of view manipulator comprising a passive optic element that redirects a first scan line from the plurality of scan lines. The 3D measuring system further includes a computing system coupled with the 3D measuring device. The 3D measuring device continuously transmits a captured data from the sensor to the computing system as the 3D measuring device is moved in an environment, the captured data is based on receiving a plurality of reflections corresponding to the plurality of scan lines, including a reflection of the first scan line that is redirected. The computing system generates a 3D point cloud representing the environment based on the captured data and stores the 3D point cloud.

In some aspects, the 3D measuring device is a time-of-flight scanner.

In some aspects, 3D measuring device is portable.

In some aspects, the sensor is a LIDAR device.

In some aspects, the 3D measuring device is configured for wireless communication with the computing system.

In some aspects, the computing system generates a 2D projection as live feedback of the movement of the 3D measuring device.

In some aspects, the 2D projection is displayed at a first map tile level, and in response to zooming into a portion of the 2D projection, a second map tile level is displayed.

In some aspects, the passive optic element is a plurality of passive optic elements.

In some aspects, the plurality of passive optic elements comprises a first optic element that redirects only the first scan line and a second optic element that redirects only a second scan line.

In some aspects, the first optic element redirects the first scan line at a first angle, and the second optic element redirects the second scan line at a second angle, distinct from the first angle.

In some aspects, the plurality of passive optic elements comprises a first optic element that redirects a first subset of the scan lines and a second optic element that redirects a second subset of the scan lines.

In some aspects, the first optic element redirects the first subset of scan lines at a first angle, and the second optic element redirects the second subset of scan lines at a second angle, distinct from the first angle.

In some aspects, the plurality of passive optic elements comprises an optic element corresponding to each respective scan line emitted by the sensor.

In some aspects, the first scan line that is redirected is originally directed to a carrier of the 3D measuring device, and the first scan line is redirected away from the carrier.

In some aspects, the field of view manipulator redirects the first scan line in a horizontal or a vertical plane with respect to a vertical axis of the sensor.

In some aspects, the passive optic element comprises a reflective surface.

In some aspects, the passive optic element comprises an absorptive surface.

In some aspects, wherein the field of view manipulator is a plurality of field of view manipulators.

In some aspects, the passive optic element of the field of view manipulator is adjustable to redirect the first scan line differently.

In some aspects, the scan lines comprises a light pulses emitted by the sensor.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1A depicts an example 3D scanning apparatus according to one or more aspects;

FIG. 1B depicts use of two sensors in an example 3D scanning apparatus according to one or more aspects;

FIG. 2 depicts an example handheld measurement device 120 according to one or more aspects;

FIG. 3 depicts an example view of a LIDAR sensor according to one or more examples;

FIG. 4 depicts an example optic element being used to manipulate the (field of view) FOV of a sensor according to one or more aspects;

FIG. 5 depicts a FOV manipulator with a plurality of optic elements according to one or more aspects;

FIG. 6 depicts an example FOV manipulator according to one or more aspects;

FIG. 7 depicts a 360-degree view of the FOV manipulation according to one or more aspects;

FIG. 8 depicts an example view where the manipulated FOV is directed towards the roof (first direction) and floor (second direction);

FIG. 9 depicts an example view of a measurement device equipped with a FOV manipulator according to one or more aspects;

FIG. 10 depicts a scanning system for capturing measurements in an environment according to one or more aspects;

FIG. 11 depicts a block diagram of a structure of the distributed processing performed by the scanning system to generate map according to one or more aspects;

FIG. 12 depicts an example point cloud;

FIG. 13 depicts a flowchart of a method for generating a map according to one or more aspects;

FIG. 14 depicts an example scenario of calibrating two lidar sensors;

FIG. 15 depicts point cloud generation according to one or more aspects;

FIG. 16 depicts a 2D image that is generated by the projection according to one or more examples;

FIG. 17 depicts generating map tiles corresponding to map according to one or more aspects; and

FIG. 18 depicts an example computer system that can be used for one or more technical solutions described herein.

The detailed description explains embodiments of the invention, together with advantages and features, by way of example with reference to the drawings.

### DETAILED DESCRIPTION

Aspects of the technical solutions described herein provide a system, a device, or an apparatus that includes a mobile 3D scanner that can include one or more sensors, such as LIDAR. The sensors can be off-the-shelf components, for example, LIDAR devices manufactured by VELODYNE® or any other manufacturer. The 3D scanner uses the sensors to capture a digital three-dimensional (3D) representation of a surrounding environment. In one or more aspects, the 3D scanner can be carried, for example, as a handheld device that facilitates measuring, capturing, and storing the 3D representation of the surrounding environment.

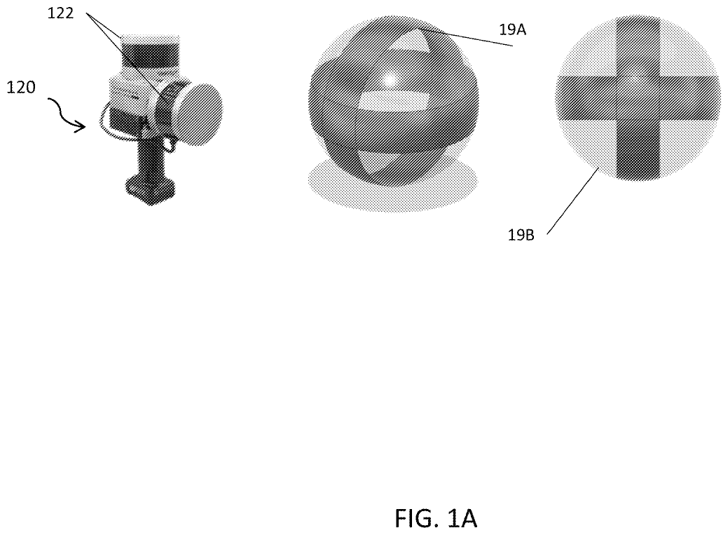

FIG. 1A depicts an example 3D scanning apparatus according to one or more aspects. In the depicted example, an operator carries a 3D scanning apparatus 120, which includes two sensors 122. The sensors 122 are LIDAR devices in the depicted example; however, the sensors 122 can be any other TOF type of sensor. The sensor 122, such as a LIDAR device, facilitate determining the distance (ranges) of a point of an object in the sensor's field of view (FOV) by targeting the object with a light pulse (e.g., laser) and measuring the time for the reflected light to return to a receiver. The sensor 122 facilitates emitting and receiving the light pulses and measuring the time between emission and reception.

The sensors 122 can be mounted on supporting mounts 2 in some examples. The mounting and positioning of the sensors with respect to the operator and/or each other can be different from that shown in the example of FIG. 1A. Each sensor 122 has a respective FOV 12. Each sensor 122 has a 360° FOV in azimuth and some value between 15-90° in zenith FOV. Accordingly, in some aspects, using two sensors with a respective angle to each other of roughly 90° (see FIG. 1B), captures 360° around azimuth (sphere 19A) and a separate 360° around zenith (sphere 19B). facilitate capturing complete (360 degrees) surroundings of the operator. It should be noted that although an operator is depicted to be carrying the measurement device 120 manually (on the back/hand) in FIG. 1A, in other examples, the measurement device 120 can be carried by the operator in a different manner. Further, in some examples, the measurement device 120 can be carried by a robotic/automated/semi-automated or manually moved platform in other examples.

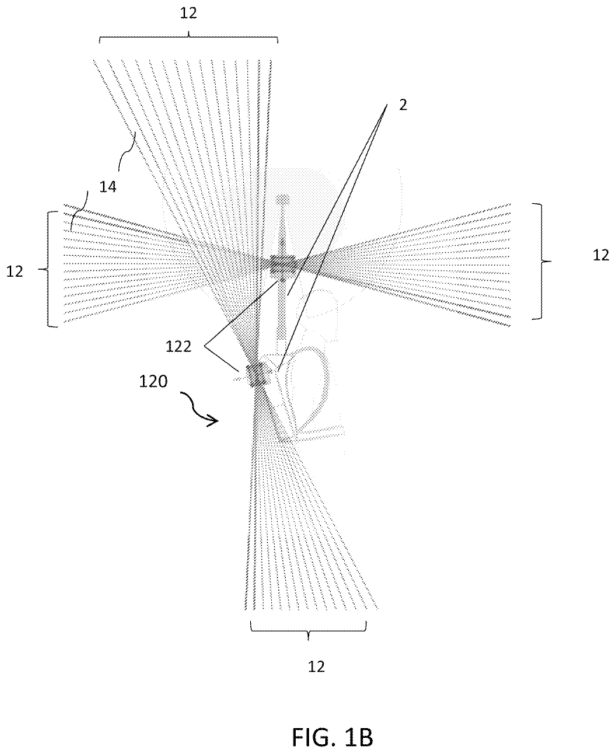

FIG. 2 depicts an example handheld measurement device 120 according to one or more aspects. The measurement device 120 operates using the same principles as the other measurement devices described herein using one or more TOF-type sensors 122. It should be noted that in other examples, the handheld measurement device 120 may be held differently from what is shown in FIG. 2.

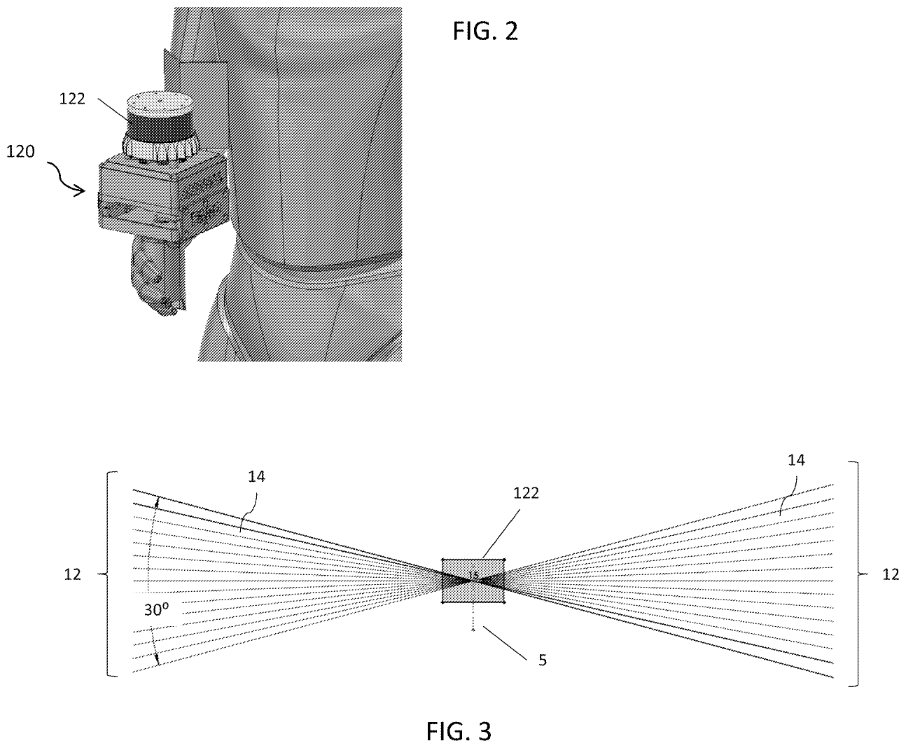

FIG. 3 depicts an example view of the LIDAR sensor according to one or more examples. In the depicted example, the sensor 122 is a puck-shaped LIDAR with sixteen scan lines 14 in a 30° vertical FOV 12 with respect to a vertical axis 5 of the sensor 122. It is understood that other types of sensors and/or lidars can be used in other examples with different FOV angles (e.g. 45 degrees) and/or with different resolutions (scan lines per degree/radian).

A technical challenge with using commercially available sensors 122, such as LIDAR devices, is that the FOV 12 is limited to a specific predetermined angle, for example, 30°, in the example of FIG. 3. Hence, to capture the entire volume of a surrounding environment, the operator would have to perform multiple scans with the sensor in different poses (e.g., rotating or angling/tilting the measurement device 120).

Existing solutions attempt to address this technical challenge by using two or more sensors (of the same type) mounted at respective orientations to capture the entire surrounding in fewer scans. However, a technical challenge exists to calibrate the multiple sensors and to optimize the respective FOVs so that the desired portion of the surrounding environment is captured by a measurement device 120. Further, the use of multiple sensors can lead to increased amounts of data being captured by the 3D scanner, which can demand additional computing resources and power to generate the 3D representation. The multiple sensors can also increase the power consumption, size, and cost of the 3D scanner.

Another technical challenge with existing measurement devices 120 is that the sensors 120 can capture undesirable objects in the FOV 12. For example, the operator (or platform) that is carrying the measurement device 120 can be in the FOV 12 of a sensor 122. Such captured data has to be “cleaned” during post-processing, for example, by identifying the operator/platform in each frame that is captured, marking, and removing or replacing that data. Alternatively, data within the field of view where the operator is located may be removed. However, this field of view would change based on the operator using the system. Such post-processing cleanup can be resource and cost-intensive.

Technical solutions described herein address such technical challenges with the existing measurement devices 120 and provide improvements to the measurement devices 120 and the process to capture the digital representation using the measurement device 120. Accordingly, the technical solutions described herein provide improvements to computing technology, including the measurement device 120 itself, as well as a system that processes the captured data from the measurement device 120. Further, the technical solutions described herein provide a practical application of capturing the entire surrounding environment with fewer scans by overcoming the limitations associated with FOVs of the sensors. Further, the practical applications include preventing undesired objects, such as the operator/platform carrying the measurement device 120, from being captured.

The technical solutions described herein address the technical challenges using the passive optic element. The passive optic element redirects the scan lines 14 to change the FOV 12. The optic element can include one or more mirrors or lenses.

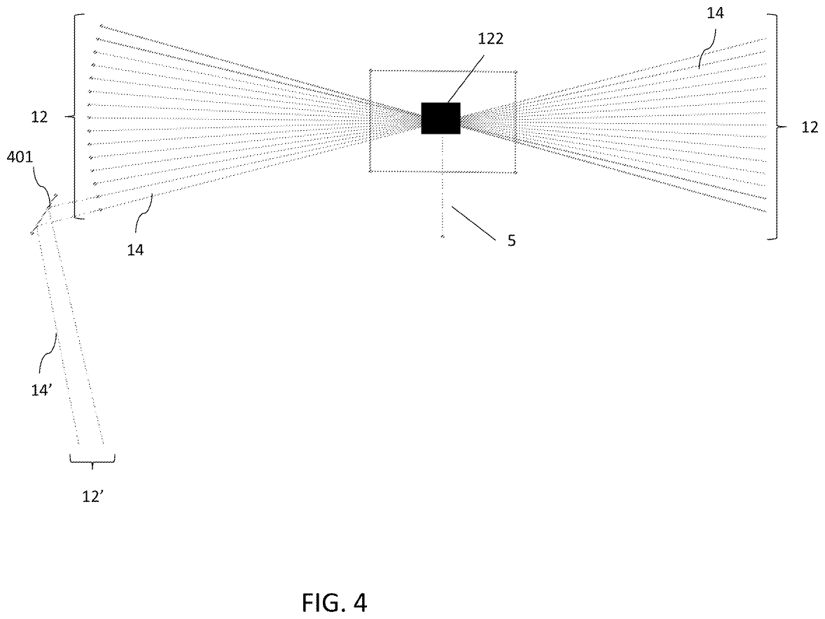

FIG. 4 depicts an example optic element being used to manipulate the FOV of a sensor according to one or more aspects. An optic element 401 is placed in the FOV 12 to divert at least a subset of the scan lines 14. The optic element 401 causes the sensor 122 to have a manipulated FOV 12′. The manipulated FOV 12′ is scanned by scan lines 14′, which can be one or more scan lines 14 depending on the size of the optic element 401. In other words, the passive optic element 401 redirects (i.e., manipulates) one or more scan lines 14 into manipulated scan lines 14′ that facilitate detecting TOF from points/objects in a manipulated FOV 12′ (which is distinct from the FOV 12).

The optic element 401 can be a passive optic element. For example, the optic element 401 can be a reflector, e.g., a mirror, that redirects the scan lines 14 incident on the optic element. The optic element 401 can be an arc segment or could extend 360 degrees. In other examples, the optic element can be an absorber, e.g., carbon nanotube arrays, that causes the scan lines 14 incident on the optic element 401 to be aborted.

The optic element 401 can be one of a plurality of optic elements in a FOV manipulator apparatus. Further, it should be noted that in one or more aspects, the passive optic elements can be placed in both (or more) sides of the sensor 122 towards which the sensor 122 emits the scan lines 14.

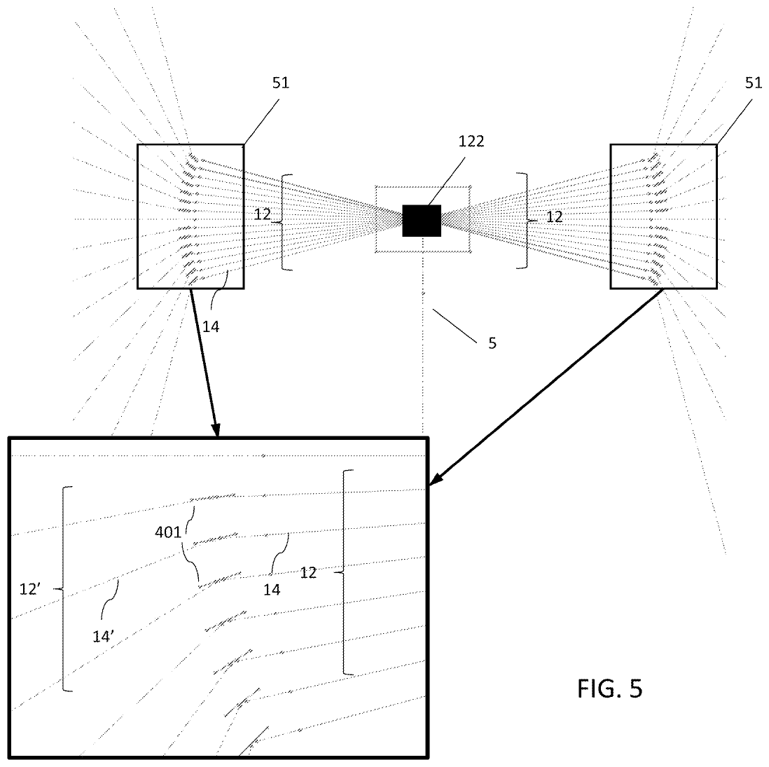

FIG. 5 depicts a FOV manipulator with a plurality of optic elements according to one or more aspects. The FOV manipulator 51 includes an assembly of a plurality of passive optic elements 401. The number of optic elements 401 in the FOV manipulator 51 can be equal to the number of (predetermined) scan lines emitted by the sensor 122 in the FOV 12. For each scan line 14 a distinct geometry can be selected for the corresponding optic element 401 to get the desired manipulated FOV 12′ (instead of the FOV 12). The “geometry” indicates a pose of the optic element 401 with respect to the scan line(s) 14 that the optic element 401 manipulates. In some examples, the geometry can be specific with respect to the vertical axis 5 of the sensor 122, or based on any other coordinate system as reference. The geometry of an optic element 401 can be changeable in some examples to facilitate the FOV manipulator 51 to be adjusted based on the surrounding environment.

In other examples, the number of optic elements 401 in the FOV manipulator 51 can be different, for example, corresponding to only specific scan lines 14 that are to be redirected.

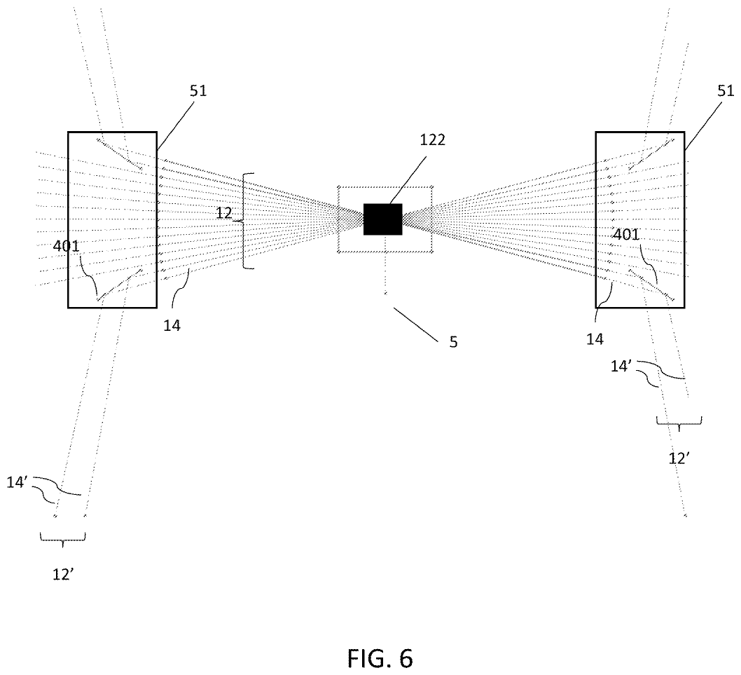

FIG. 6 depicts an example FOV manipulator according to one or more aspects. The FOV manipulator 51 in FIG. 6 includes only two optic elements 401 for the FOV 12. Each optic element 401 redirects two scan lines 14 to cause a manipulated FOV 12′. The rest of the scan lines 14 in the FOV 12 are not redirected by the FOV manipulator 51.

The redirection provided by the optic elements 401 of the FOV manipulator 51 can be in any direction (360 degrees).

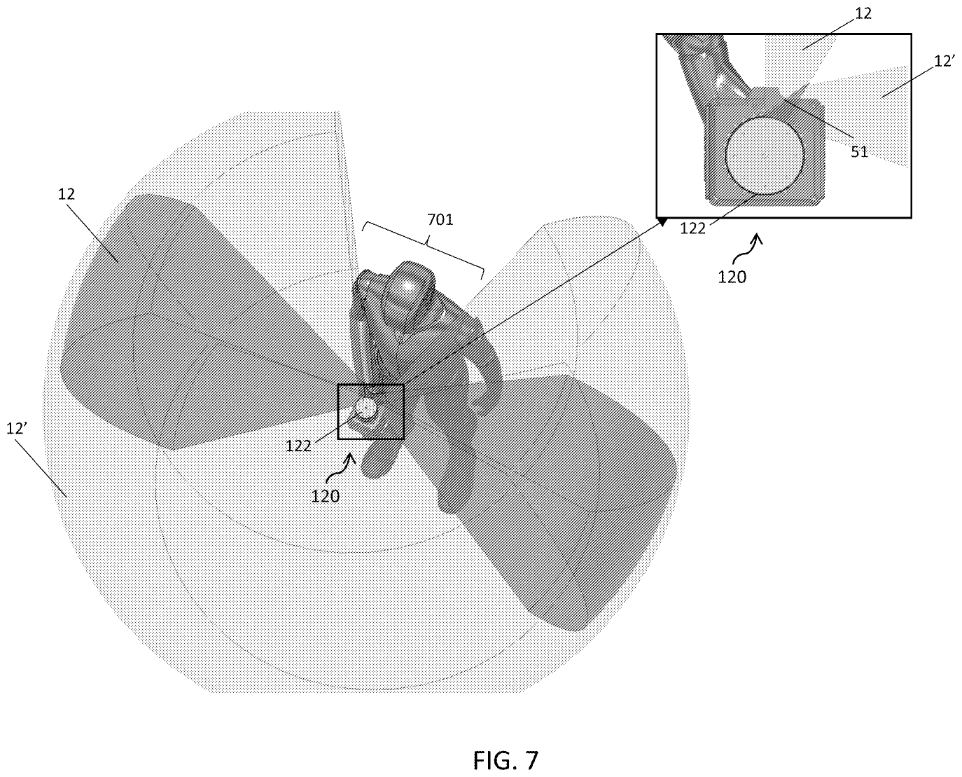

FIG. 7 depicts a 360-degree view of the FOV manipulation according to one or more aspects. The FOV 12 can be manipulated in any direction to capture data from an extended FOV 12′. In addition, in some examples, the FOV 12′ is manipulated instead of the FOV 12 in the direction 701 of the operator/carrier. In this manner, scan lines 14, which would have been directed towards the direction 701 in which the operator/carrier is with respect to the measurement device 120, are redirected in the direction of 12′. Accordingly, the redirected scan lines 14′, instead of capturing the operator/carrier (which requires post-process clean up), captures data from the surroundings in the manipulated FOV 12′.

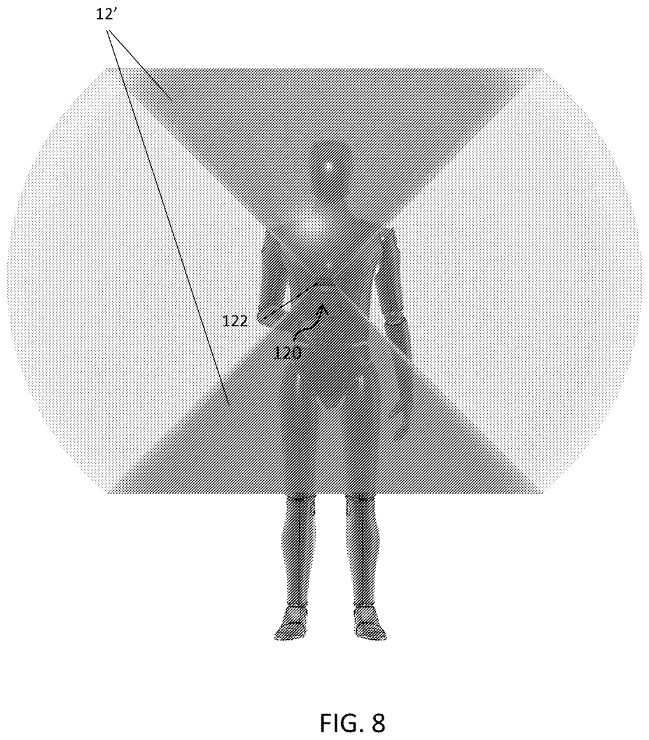

In some aspects, the manipulation of the FOV 12 in 360 degrees enables scanning the floor and ceiling with the measurement device 120 in a single capture or scanning session. In other words, the operator could simply walk through the environment and capture a volume of data without having to reorient the measurement device 120. FIG. 8 depicts an example view where the manipulated FOV 12′ is directed towards the roof and floor, for example, instead of the operator.

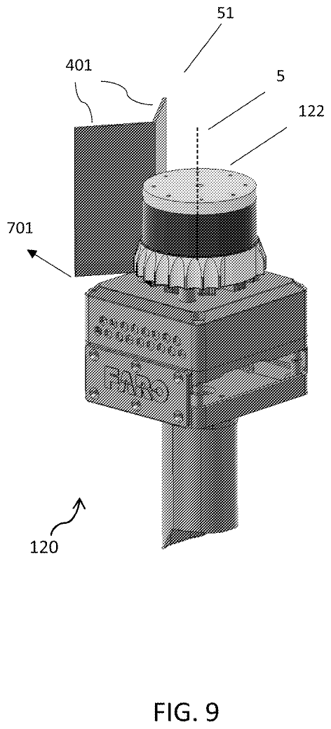

FIG. 9 depicts an example view of a measurement device equipped with a FOV manipulator according to one or more aspects. The measurement device 120 can be any 3D scanner with a LIDAR sensor 122, as shown in the illustration. In other aspects, the sensor can be mounted in a different manner than shown. The sensor 122 facilitates generating the digital 3D representation of the surrounding by capturing digital representations in the FOV 12 (shown in other FIGS.). The FOV manipulator 51 can be equipped at a certain pose with respect to the sensor 122 to redirect one or more of the scan lines 14 in a specific direction, for example, the direction 701 in which the operator/carrier is present. It is understood that the FOV manipulator 51 can include more or fewer optic elements 401 than those shown in the illustration. Further, the geometry of the optic elements 401 can be different from what is shown in the illustration in other examples. Additionally, the geometry of each optic element 401 in the FOV manipulator 51 can be distinct and is dependent on the specifications of the scan lines 14 emitted by the sensor 122. In one or more aspects, the measurement device 120 can be equipped with more than one FOV manipulator 501.

Aspects of the technical solutions address the technical challenge and need to capture a location in 3D as fast as possible. Scanning with existing 3D scanning systems can take a long time. A cause for such delay includes that multiple stationary scans have to be taken, which are then “registered” with each other using overlapping portions. Presently available solutions typically use landmarks (artificial or natural) to recognize the overlap for such registration. Further, current 3D scanning systems are fixed to a floor/level and cannot be easily used for capturing environments/situations in which multiple levels/floors (e.g., an office building, multistory house, etc.).

As used herein, unless explicitly indicated otherwise, “mobile mapping” is the process of measuring and collecting geospatial data by a mobile 3D scanning system. The 3D scanning system, according to one or more aspects of the technical solutions described herein, can be a backpack, a trolley, a handheld device, an autonomous robot, or any other mobile form. The 3D scanning system uses remote sensing systems like lidar cameras in combination with inertial and navigation sensors, e.g., an inertial measurement unit (IMU), for mobile mapping. Further, as used herein, unless explicitly indicated otherwise, simultaneous localization and mapping (SLAM) is a technique/algorithm that a mobile 3D scanning system uses to incrementally build a map of the surrounding environment while the 3D scanning system is moving or has been moved, simultaneously localizing itself on the map. A “map” is a 2D or 3D representation of the environment seen through the various sensors of the 3D scanning system. The map is represented internally as a grid map. The grid map is a 2D or 3D arranged collection of cells representing an area of the environment. The grid map stores, for every cell, a probability indicating if the cell area is occupied or not based on the measurement(s) from the 3D scanning system. In some examples, the 3D scanning system can include lidar sensors which produce a 3D point cloud as output. Technical solutions are not restricted or limited to specific lidar sensors and can include lidar sensors from VELODYNE®, OUSTER®, or any other manufacturer.

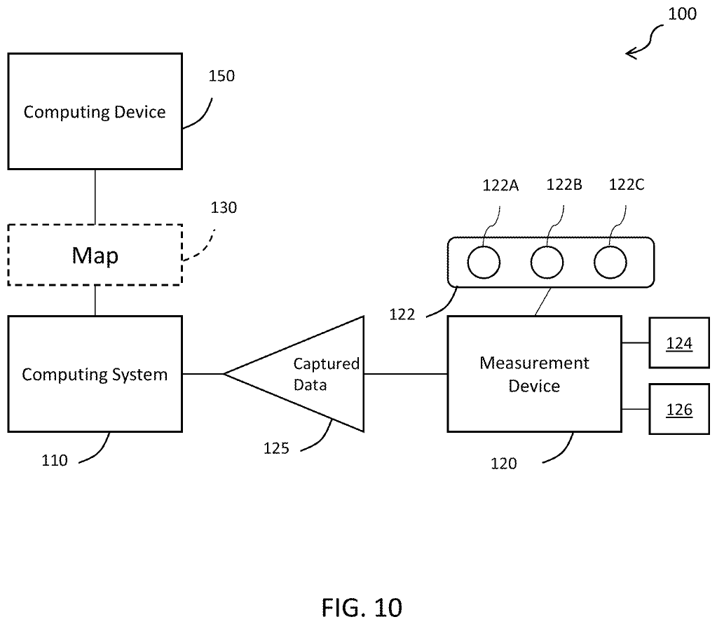

FIG. 10 depicts a scanning system for capturing measurements in an environment according to one or more aspects. The scanning system 100 includes a computing system 110 coupled with a measurement device 120. The coupling facilitates electronic communication of data and instructions between the computing system 110 and the measurement device 120. The communication can be performed in a wired or wireless manner. The measurement device 120 can be a 2D scanner, a 3D scanner, a camera, a drone-based camera, or any other measurement device or a combination thereof. The computing system 110 can be a computer server or any other type of computing device that facilitates remote storage and processing of the captured data 125.

The captured data 125 from the measurement device 120 includes measurements of a portion from the environment. The captured data 125 is transmitted to the computing system 110 for processing and/or storage. The computing device 110 can store the captured data 125 locally, i.e., in a storage device in the computing device 110 itself, or remotely, i.e., in a storage device that is part of another computing device 150. The computing device 150 can be a computer server or any other type of computing device that facilitates remote storage and processing of the captured data 125.

The captured data 125 from the measurement device 120 can include 2D images, 3D point clouds, a distance of each point in the point cloud(s) from the measurement device 120, color information at each point, radiance information at each point, and other such sensor data captured by the set of sensors 122 that is equipped on the measurement device 120. For example, sensors 122 can include a LIDAR 122A, a depth camera 122B, a camera 122C, etc. The 2D images can be panorama images (e.g., wide-angle images, ultra-wide-angle images, etc.) in some cases. The measurement device 120 can also include an inertial measurement unit (IMU) 126 to keep track of a pose, including a 3D orientation, of the measurement device 120. Alternatively, or in addition, for the captured data 125, the pose can be extrapolated by using the sensor data from sensors 122, the IMU 126, and/or from sensors besides the range finders.

In one or more aspects, the measurement device 120 can also include a global positioning sensor (GPS) (not shown) or another such location-sensing module that facilitates identifying a global position of the measurement device 120. While there are solutions that use photogrammetry using GPS information, for example, for scaling, such techniques have significant errors (˜5-10%) because of the errors in the kinematic GPS measurement. While such techniques may be suitable for generating maps of large spaces (e.g., 5 square miles+) where the lower accuracy can be compensated, such errors are not acceptable when generating a map of a relatively smaller area, such as an office building, a factory, an industrial floor, a shopping mall, a construction site, and the like.

It should be noted that while only a single measurement device 120 is depicted, in some aspects, multiple measurement devices 120 can transmit respective captured data 125 to the computing system 110. In some examples, a first measurement device 120 is a 2D scanner, a second measurement device 120 is a 3D scanner, a third measurement device 120 is a camera, etc. Each of the measurement devices 120 transmits a captured data 125 to the computing system 110 concurrently in some aspects.

To address the technical challenges with existing 3D scanning systems and to facilitate capturing a map 130 of the surrounding in real-time using the mobile measurement device 120, aspects of the technical solutions described herein use distributed processing. The distributed processing comprises running a subset of the operations for generating the map 130 on the measurement devices 120 and another subset of the operations on the computing system 110 (i.e., cloud platform), which can process data from the different measurement devices 120. Accordingly, the technical challenge of the limited processing power available at the measurement devices 120 (for example, necessitated by the portability) can be overcome. Further, the distributed processing facilitates updating the computing system 110 (for example, to correct errors, add features, etc.) faster than updating the (local) measurement devices 120.

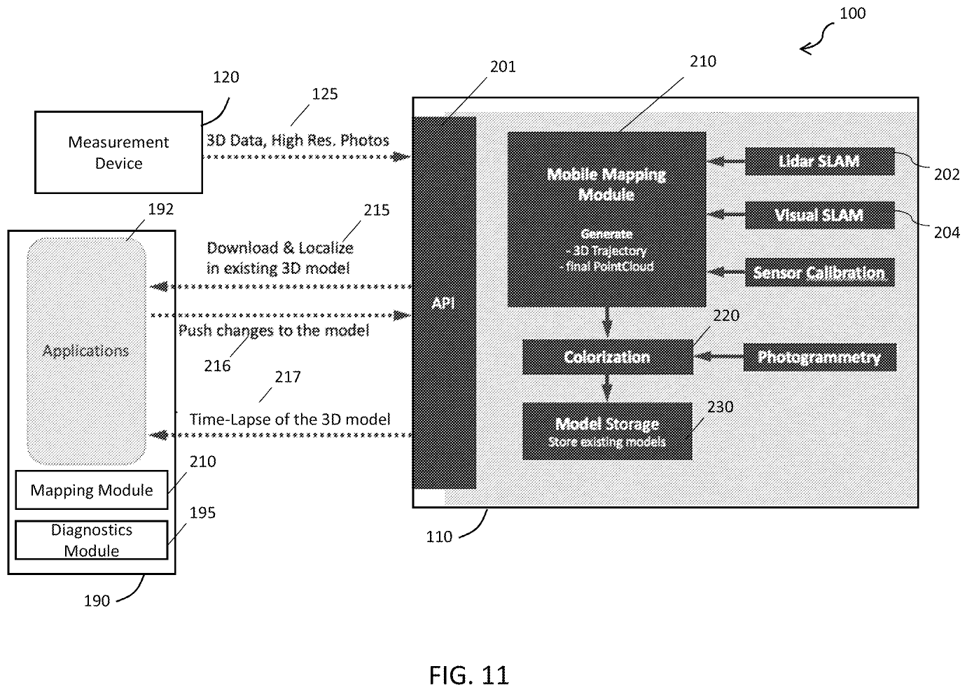

FIG. 11 depicts a block diagram of a structure of the distributed processing performed by the scanning system 100 to generate map 130 according to one or more aspects. The measurement device 120 transmits the captured data 125 to the computing system 110, i.e., the “cloud.” The computing system 110 processes the captured data 125 to generate an output 215. The output 215 includes at least a portion of the map 130.

In some aspects, one or more applications 192 receive the output 215. The one or more applications 190 can be software or computer programs in some aspects. The applications 192 may be executing on a computing device 190. The computing device 190 can be different from the computing system 110 in some aspects. For example, the computing device 190 can be a mobile phone, a tablet computer, a laptop computer, or any other type of portable computing device that may have limited computing resources. The computing device 190 communicates with the computing system 110 in a wired or wireless manner, for example, using a computer network, such as the Internet. In other aspects, the computing device 190 is the computing system 110 itself, or part of the computing system 110. In some examples, the computing device 190 can be the measurement device 120 itself or associated with the measurement device 120.

The computing device 190, in some aspects, can transmit to the computing system 190, one or more requests 216 to change one or more portions of the map 130. The changes can be based on, for example, localization of a portion of the map 130 included in the output 215, resulting in misalignment. Alternatively, or in addition, the computing system 190 can provide a time-lapse 217 of a 3D model generated based on the captured data 125.

The computing system 110 can provide an application programming interface (API) 201 to facilitate communication with external components such as the measurement device 120 and the computing device 190. The API 201 can be accessed by the external components to provide the captured data 215, the requests 216, and to receive the output 215, the time-lapse of the 3D model 217, and other communications. Predetermined communication protocols and data structures are used to communicate the electronic data between the computing system 110 and the measurement device 120 and the computing device 190. For example, standards associated with the robot operating system (ROS) can be used for transferring the data using *.BAG file protocols. Other types of predetermined data standards can be used in other examples, and the data structures and protocols used for the communication do not limit the technical solutions described herein.

Based on the received inputs (e.g., captured data 125, requests 216, etc.), one or more components of the computing system 110 processes the captured data 125. It should be understood that while one possible division of the components of the computing system 110 is depicted, in other aspects of the technical solutions, the components can be structured any other way. The computing system 110 can include a mapping module 210 that generates a trajectory of the measurement device 120 in the map 130 based on the captured data 125. The mapping module 210 can also be responsible for generating a point cloud representing the surrounding environment. In some examples, the point cloud is part of the map 130.

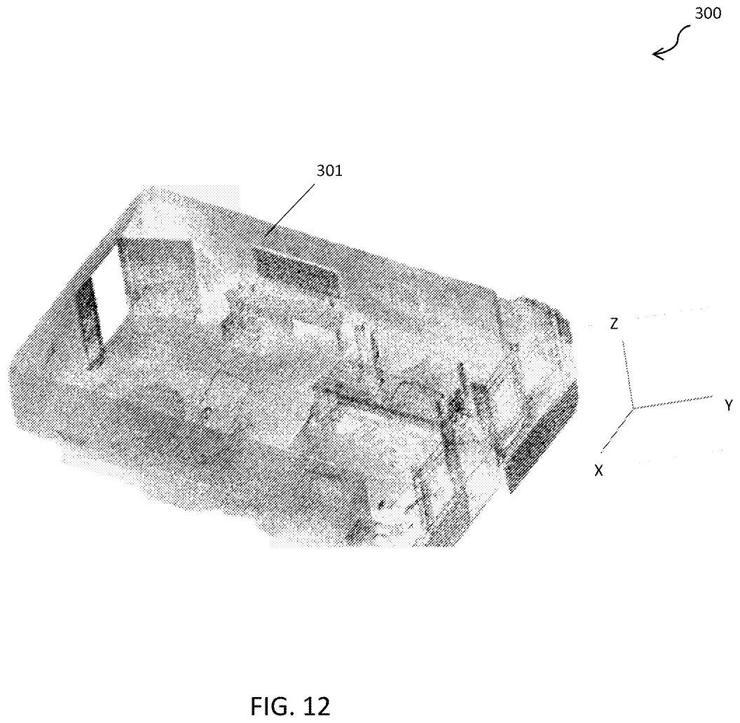

FIG. 12 depicts an example point cloud. A “point cloud” 300 is a collection of individual data points 301 in a 3D plane, with each data point 301 having a set coordinate on the X, Y, and Z-axis. A 3D model can be represented by rendering each of the data points 301 in the point cloud 300 together. For example, in the illustrated case, the data compiled to create the point cloud 300 is taken from a room to depict the location of each door, window, and any other object (e.g., bed, rug, etc.) in the room. Depending on the data points 301 captured and the density of the point cloud 300, the clarity (or quality) of details and specific types of features and structures will vary.

Referring to FIG. 11, the mapping module 210 is responsible for executing one or more SLAM algorithms, such as lidar SLAM 202, visual SLAM 204, etc. The mapping module 210 uses the captured data 215. Further, the mapping module 210 uses information about the actual measurement device 120 that captured the data, i.e., which sensors were used, calibrations, etc. With such information, the mapping module 210 performs a mapping for the different types of sensors 122, i.e., lidars, cameras, IMUs 126, etc. The “mapping” includes aligning the measurements from the several sensors into a homogenous coordinate system as well as ensuring timestamp synchronization across the sensors. The mapping module 210 generates a 3D point cloud 300 in this manner.

The computing system 110 further includes a colorization module 220, which in some aspects colorizes the 3D point cloud 300 that is generated by the mapping module 210. Colorization includes assigning a color to each data point 301 in the point cloud 300. The colorization can be performed using known techniques such as applying a “texture” using a color image captured by a camera. The color image can be a panoramic or fish-eye image in one or more examples. The color image can be aligned with the 3D point cloud 300 using photogrammetry 222 in one or more examples. Other techniques can also be used to colorize the 3D point cloud 300 in other examples.

The 3D point cloud 300 with and/or without colorization is stored by the computing system 110 in a model storage 230.

The 3D point cloud 300 is provided to the computing device 190 as part of the output 215. In one or more examples, the computing device 190 also includes an instance of the mapping module 210. In some aspects, two different instances of the same mapping module 210 are executed, a first instance on the computing system 110, and a second instance on the computing device 190. The second instance has different (relaxed) settings from the first instance of the mapping module 210. The second instance performs a live mapping of the 3D point clouds in the output(s) 215 generated by the computing system 110. The second instance generates a preview of the map 130 using the outputs from the computing system 110. The generated preview can be 2D or 2.5D map (2.5D means a 2D map with different floors/levels/stories). Alternatively, the preview visualizes the 3D point cloud 300 with a lower predetermined resolution.

Additionally, the computing device 190 includes a diagnostics and logging module 195 that saves information about the settings and calibration of the computing device 190.

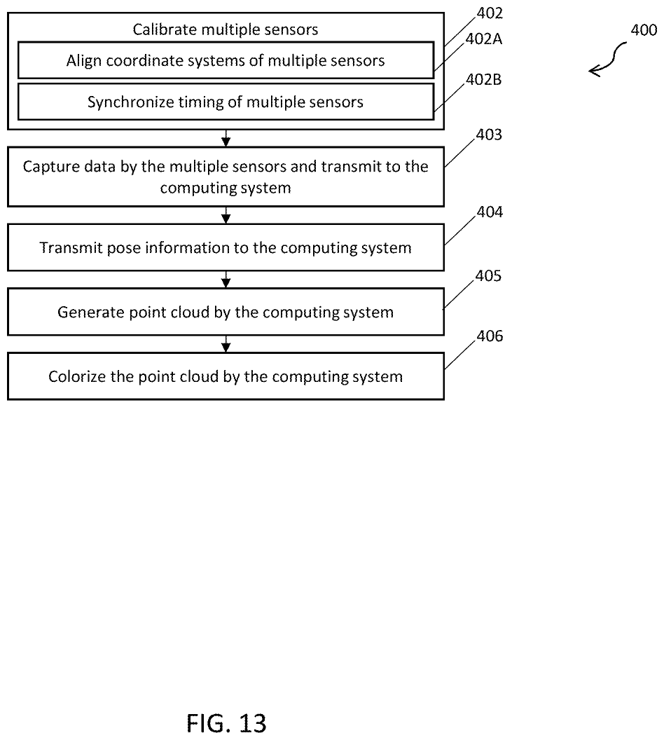

FIG. 13 depicts a flowchart of a method 400 for generating the map 130 of a surrounding environment as the measurement device 120 is transported in the surrounding environment and providing, as feedback, a real-time preview of the map 130 that is being generated. The method 400 includes, at block 402, calibrating the sensors 122 of the one or more measurement devices 120. At block 402A, the multiple sensors are calibrated to generate measurements on a single trajectory and a common coordinate system of a point cloud. When multiple sensors are used, the coordinate systems of the multiple sensors have to be aligned to a single coordinate system. For example, if the measurement device 120 includes two lidars, the measurements from both lidars have to be aligned to a common (single) coordinate system. The common coordinate system can be that of one of the two lidars or a third coordinate system independent of the two lidars.

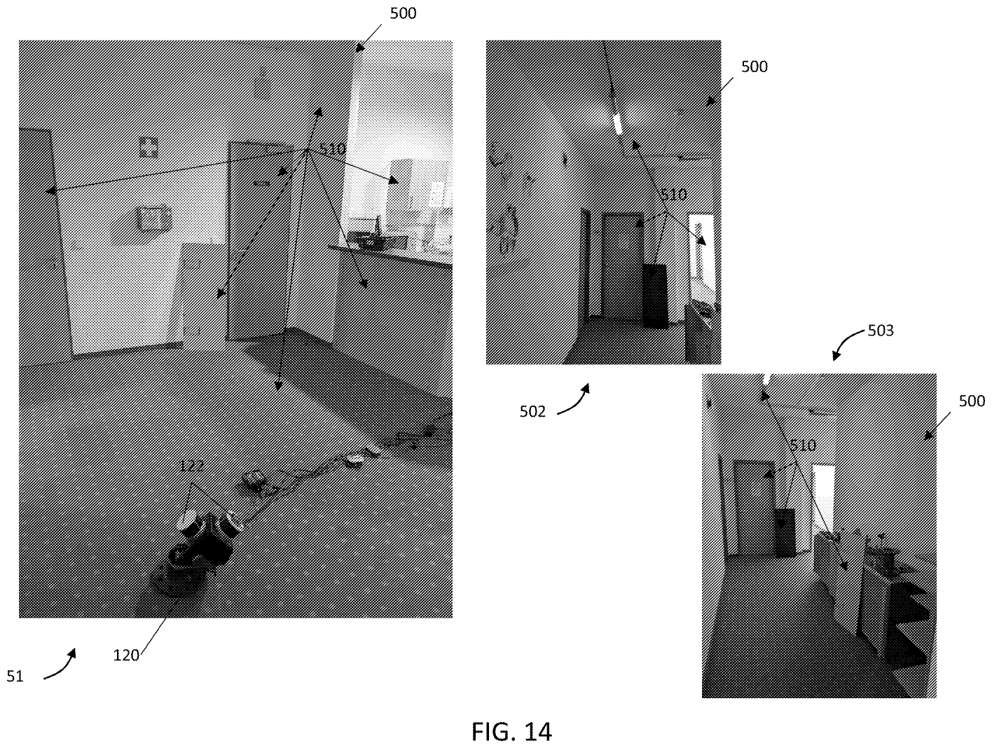

FIG. 14 depicts an example scenario of calibrating two lidar sensors. In the example scenario, a measurement device 120, in this case, a handheld TOF scanner, is placed in an environment 500, in this case, a room. The views 501, 502, 503 depict the measurement device 120 being placed at three different positions in the environment 500 to perform three calibrations. In other aspects, the number of calibrations can be different (fewer/more) than three.

The measurement device 120 has two LIDAR devices 522 in this embodiment. In an embodiment, it is desirable to calibrate the two LIDAR devices 522 to generate data on a single trajectory and as part of a single point cloud. It is understood that although only two LIDAR devices 522 are being calibrated in the depicted example, the technical solutions can be used to calibrate several sensors as described herein. Also, it is understood that while VELODYNE® LIDAR devices 522 are depicted, the technical solutions described herein can be used for lidars from other manufacturers and are not limited to specific lidars. The calibration of the two LIDAR devices facilitates aligning the coordinate systems of the two lidars 522.

The position of the measurement device 120 for the calibrating in the views 501, 502, 503 facilitates placing multiple planes 510 in the field of view of both lidars 522. These planes 510 have to be linearly independent to facilitate determining a 6DOF pose of the planes 510 inside the coordinate systems of both LIDAR devices 522. The planes 510 can include any type of plane that can be detected by the sensors, and in this case, the planes 510 include floors, walls, windows, doors, furniture, or any other objects/items that can be detected by the LIDAR devices 522.

The planes 510 that are extracted from the data captured by the measurement device in this calibration position. The extraction can be performed either manually or automatically. Plane extraction can be performed using computer vision algorithms such as hierarchical plane extraction or the like. The same planes from the two separate data captures from the two LIDAR devices 522 at each calibration position are fitted to each other using known plane fitting techniques. The transformation that has to be applied to fit a first instance of a plane (e.g., a door) that is captured by the first LIDAR device 522 to a second instance of the same plane (i.e., the door) that is captured by the second LIDAR device 522 is used as the calibration transformation for the two LIDAR devices. When there are multiple planes (as in the example), the transformation that fits all of the planes from the two captured datasets is determined and used as the calibration transformation. The optimization problem can be formulated as finding a transformation T such as All planes from one Lidar L1 transformed by the transformation T are on the same corresponding plane from the other Lidar L2.

To reduce the effect of inaccurate calibrations, especially when the planes are at distances beyond a predetermined threshold (e.g., 20 feet, 30 feet, etc.), only the vertical sensor (pointing to the ceiling in the depicted example) for the final point cloud generation is used, in some aspects. Such selective use of the sensors 122 improves the quality of the captured data. For example, by selectively using only the vertical sensor, the data captured by the horizontal sensor is preemptively filtered because the horizontal sensor (pointing to the walls in the depicted example) can capture walls and other items multiple times and may lead to the accumulation of error(s).

Referring to the flowchart in FIG. 13, calibrating the sensors further includes, at block 402B, synchronizing timing across the multiple sensors 122. Timestamping the captured data from the sensors is crucial for the quality of the mapping. If the timestamps of the sensors are different in relation to each other, the processing places the captured data at positions away from each other. Software-based timestamping of the incoming data is inaccurate and can also depend on the amount of data being processed by the measurement device 120 (system load). Such a technical challenge of synchronizing the sensors is addressed by using a precision clock synchronization protocol for networked measurement and control. In an example protocol, the clocks of two LIDAR devices 522 are synchronized to a grandmaster clock (third independent clock). The protocol supports system-wide synchronization accuracy in the sub-microsecond range with minimal network and local clock computing resources. Other types of timing synchronization can be implemented in other examples.

At block 404, sensor measurements of the surrounding environment are captured by the measurement devices 120 and transmitted to the computing system 110. The measured sensor data is the captured data 125. The sensors usually run at 20 Hz and produce a complete point cloud per sweep. This leads to a large amount of data per sweep. The data has to be transmitted to the computing system 110 for further processing. If the data is too large (multiple megabytes), data transfer can limit the speed at which the map 130 is generated. Accordingly, to address the technical challenge of the amount of data being generated by the sensors, technical solutions described herein only record the raw data of the LIDAR device, which does not contain a 3D point measurement but only distance and angle information. This reduces the amount of data by a factor ˜5. Furthermore, to reduce the transfer time of the data to the computing system 110 an external storage device (not shown) is plugged into the measurement device 120 where the captured data is stored. In some aspects, for transferring the captured data to the computing system, the external storage is plugged and read into the computing system 110. Alternatively, or in addition, the data that is stored in the external storage is uploaded to the computing system 110 via WIFI®, 4G/5G, or any other type of communication network.

At block 406, the measurement device 120 transmits pose-information of the measurement device 120 to the computing system. At block 408, the mapping module 210 of the computing system 120 performs mapping to generate a 3D point cloud 300 of the surrounding using the captured data 125, calibration data, and pose information based on one or more SLAM algorithms. Further, at block 410, the 3D point cloud 300 may be colorized.

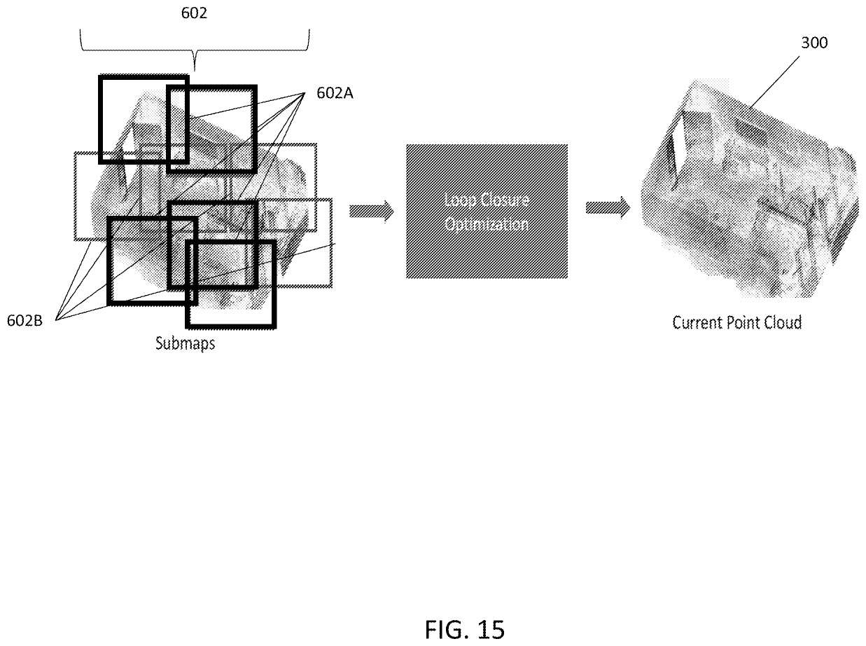

FIG. 15 depicts point cloud generation according to one or more aspects of the technical solutions described herein. In the point cloud generation in FIG. 15, the mapping module 210 uses the graph SLAM algorithm in which the recorded and registered point clouds generated by the LIDAR devices 522 are grouped together in submaps 602. The submaps 602 can be freely moved by the SLAM algorithm in the process of global optimization to find loop closures and reduce the systematic drift over time. For every single timepoint, the point cloud 300 can be generated by merging all of the submap point clouds 602 together. The submaps 602 represent the captured data 125 that is received from the measurement device 120, i.e., the LIDAR devices 522, over time. The submaps 602 can include a first subset of submaps (e.g., submaps 602A) received from the first LIDAR device and a second subset of submaps (e.g., submaps 602B) received from the second LIDAR device.

The 3D point cloud 300 is stored into the model storage 230, at block 412. The storage can include updating the map 300 of the surrounding environment 500 that is stored in the model storage 230 by appending the 3D point cloud 300 in the stored map 300.

As noted, the technical solutions herein further provide user confidence that areas s/he is mapping lead to a usable point cloud by providing real-time feedback and preview of the map 300 that is being generated by the computing system 110. Existing scanning systems may not give any feedback during scanning, and after all the processing is completed, users can notice parts of the point cloud that are misaligned. This can cause the user to capture all or at least a portion of the data again, which can be resource and time-intensive. In some cases, the user may have already left the premises of the environment that was to be captured, making the corrections even more challenging. Further, rendering a full 3D point cloud 300 for display is computationally intensive and unintuitive for many user workflows (e.g., navigation in a point cloud on a mobile touch device is not user-friendly).

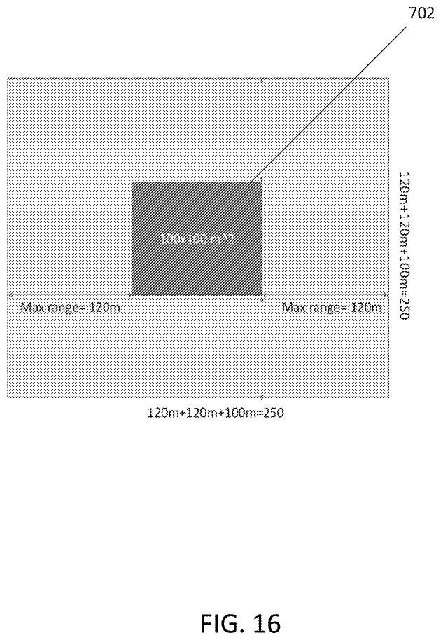

Accordingly, at block 414, a 2D visualization is generated for providing “live” (i.e., real-time) feedback that is responsive as the user moves the measurement device 122 in the surrounding environment. The 2D visualization is generated by the computing system 110 and output to the computing device 190 in some aspects. For the generation of the live feedback, the submaps 602 are used to project a representation of the point cloud 300 onto a 2D plane, resulting in a 2D image that can be shown for the 2D visualization. The 2D image that is generated can be large. FIG. 16 depicts a 2D image 702 that is generated by the projection according to one or more examples. In the example, consider mapping an outdoor area with a LIDAR range set to 120 m. In such a case, the measurement device 120 generates the map 130 with a resolution of 5 cm per grid. Accordingly, for a 10000 m² area that is scanned by the measurement device 120, the 2D image 702 that is projected can have a size of up to (100 m+240 m)*20 cells/m*(100 m+240 m)x*20 cells/m=6800 pixels×6800 pixels=46.24 megapixel). Providing live feedback in real-time when generating the 2D image 702 can be technically challenging for that size. Hence, in one or more aspects, the 2D projected map is periodically split to generate map tiles.

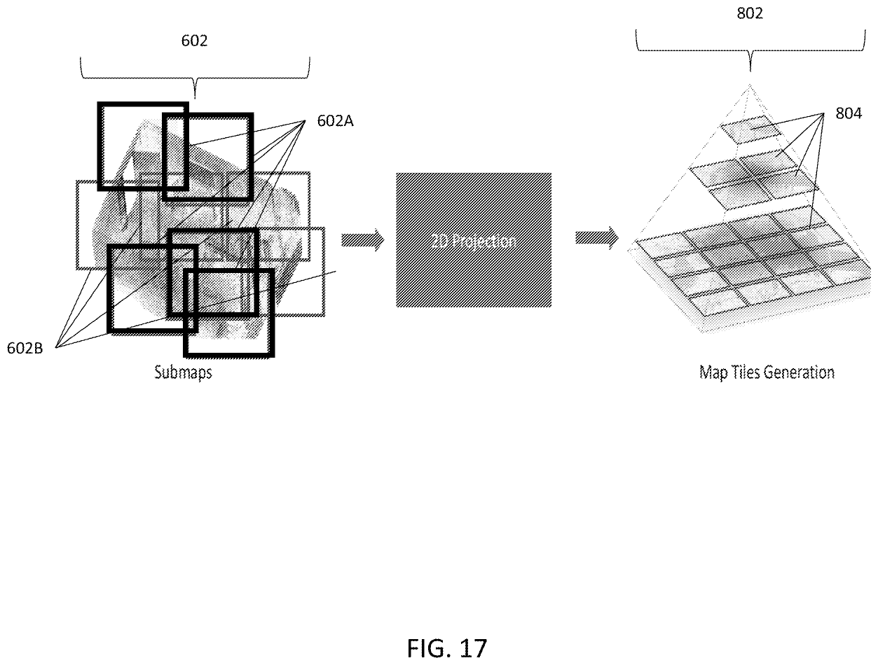

FIG. 17 depicts generating map tiles corresponding to the map 130 according to one or more aspects of the technical solutions herein. The map tiles provide a lower resolution 2D image 802 that is divided into smaller parts called tiles 804. Depending on the zoom level on the computing device 190, the corresponding map tile level is displayed. For example, on the highest zoom level, the computer device 190 displays the lowest resolution map tiles (i.e., least detail). Once the operator zooms into a certain area of the map 130, only map tiles 804 covering that certain area are visualized. This allows a user to see the overall captured environment and also if desired, see the details of specific areas by zooming into the specific areas to be inspected. Map tiles 804 are used in combination with a point cloud 300 that can be composed of billion(s) of data points 301 to facilitate the real-time view of the 2D projection of the point cloud 300. Map tiles 804 are generated using known techniques for visualizing large 3D datasets.

The low latency in the visualization to facilitate the real-time view can be achieved by caching the 2D image 702. In some aspects, once the initial map tiles are generated, the user can immediately navigate/zoom on the overall 2D map 702. Further, if a submap 602 moves in the process of loop closure or if a new submap 602 is added, the 2D image 702 is updated in response. Only the parts of the cached 2D image that belong to the submaps 602 that was moved (in the process of loop closure) or were newly added are updated. Accordingly, the update uses fewer resources than required for updating the entire 2D image 702. Accordingly, the time required for the update is reduced, facilitating real-time feedback.

It should be appreciated that the examples of measurement devices depicted herein can further be attached to an external camera to capture the identity images 310, in addition to any of the cameras that are already associated with the measurement devices.

Terms such as processor, controller, computer, DSP, FPGA are understood in this document to mean a computing device that may be located within an instrument, distributed in multiple elements throughout an instrument, or placed external to an instrument.

In one or more aspects, the captured data 125 can be used to generate a map 130 of the environment in which the measurement device 120 is being moved. The computing device 110 and/or the computing device 150 can generate map 130. Map 130 can be generated by combining several instances of the captured data 125, for example, submaps. Each submap can be generated using SLAM, which includes generating one or more submaps corresponding to one or more portions of the environment. The submaps are generated using the one or more sets of measurements from the sets of sensors 122. The submaps are further combined by the SLAM algorithm to generate map 130.

It should be noted that a “submap” is a representation of a portion of the environment and that map 130 of the environment includes several such submaps “stitched” together. Stitching the maps together includes determining one or more landmarks on each submap that is captured and aligning and registering the submaps with each other to generate map 130. In turn, generating each submap includes combining or stitching one or more sets of captured data 125 from the measurement device 120. Combining two or more captured data 125 requires matching or registering one or more landmarks in the captured data 125 being combined.

Here, a “landmark” is a feature that can be detected in the captured data 125, and which can be used to register a point from a first captured data 125 with a point from a second captured data 125 being combined. For example, the landmark can facilitate registering a 3D point cloud with another 3D point cloud or registering an image with another image. Here, the registration can be done by detecting the same landmark in the two captured data 125 (images, point clouds, etc.) that are to be registered with each other. A landmark can include but is not limited to features such as a doorknob, a door, a lamp, a fire extinguisher, or any other such identification mark that is not moved during the scanning of the environment. The landmarks can also include stairs, windows, decorative items (e.g., plant, picture-frame, etc.), furniture, or any other such structural or stationary objects. In addition to such “naturally” occurring features, i.e., features that are already present in the environment being scanned, landmarks can also include “artificial” landmarks that are added by the operator of the measurement device 120. Such artificial landmarks can include identification marks that can be reliably captured and used by the measurement device 120. Examples of artificial landmarks can include predetermined markers, such as labels of known dimensions and patterns, e.g., a checkerboard pattern, a target sign, spheres, or other such preconfigured markers.

In the case of some of the measurement devices 120, such as a volume scanner, the computing device 110, 150 can implement SLAM while building the scan to prevent the measurement device 120 from losing track of where it is by virtue of its motion uncertainty because there is no presence of an existing map of the environment (the map is being generated simultaneously). It should be noted that in the case of some types of measurement devices 120, SLAM is not performed. For example, in the case of a laser tracker 20, the captured data 125 from the measurement device 120 is stored without performing SLAM.

It should be noted that although the description of implementing SLAM is provided, other uses of the captured data (2D images and 3D scans) are possible in other aspects of the technical solutions herein.

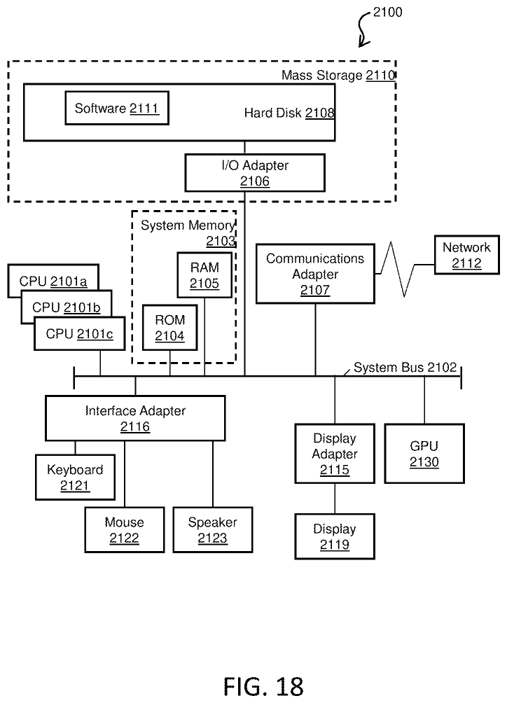

Turning now to FIG. 18, a computer system 2100 is generally shown in accordance with an aspect. The computer system 2100 can be used as the computing device 110 and/or the computing device 150. The computer system 2100 can be an electronic, computer framework comprising and/or employing any number and combination of computing devices and networks utilizing various communication technologies, as described herein. The computer system 2100 can be easily scalable, extensible, and modular, with the ability to change to different services or reconfigure some features independently of others. The computer system 2100 may be, for example, a server, desktop computer, laptop computer, tablet computer, or smartphone. In some examples, computer system 2100 may be a cloud computing node. Computer system 2100 may be described in the general context of computer system executable instructions, such as program modules, being executed by a computer system. Generally, program modules may include routines, programs, objects, components, logic, data structures, and so on that perform particular tasks or implement particular abstract data types. Computer system 2100 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 18, the computer system 2100 has one or more central processing units (CPU(s)) 2101a, 2101b, 2101c, etc. (collectively or generically referred to as processor(s) 2101). The processors 2101 can be a single-core processor, multi-core processor, computing cluster, or any number of other configurations. The processors 2101, also referred to as processing circuits, are coupled via a system bus 2102 to a system memory 2103 and various other components. The system memory 2103 can include a read-only memory (ROM) 2104 and a random access memory (RAM) 2105. The ROM 2104 is coupled to the system bus 2102 and may include a basic input/output system (BIOS), which controls certain basic functions of the computer system 2100. The RAM is read-write memory coupled to the system bus 2102 for use by the processors 2101. The system memory 2103 provides temporary memory space for operations of said instructions during operation. The system memory 2103 can include random access memory (RAM), read-only memory, flash memory, or any other suitable memory system.

The computer system 2100 comprises a graphics processing unit (GPU) 2130 that can include one or more processing cores and memory devices. The GPU can be used as a co-processor by the processors 2101 to perform one or more operations described herein.

The computer system 2100 comprises an input/output (I/O) adapter 2106 and a communications adapter 2107 coupled to the system bus 2102. The I/O adapter 2106 may be a small computer system interface (SCSI) adapter that communicates with a hard disk 2108 and/or any other similar component. The I/O adapter 2106 and the hard disk 2108 are collectively referred to herein as mass storage 2110.

Software 2111 for execution on the computer system 2100 may be stored in the mass storage 2110. The mass storage 2110 is an example of a tangible storage medium readable by the processors 2101, where the software 2111 is stored as instructions for execution by the processors 2101 to cause the computer system 2100 to operate, such as is described hereinbelow with respect to the various Figures. Examples of computer program product and the execution of such instruction is discussed herein in more detail. The communications adapter 2107 interconnects the system bus 2102 with a network 2112, which may be an outside network, enabling the computer system 2100 to communicate with other such systems. In one aspect, a portion of the system memory 2103 and the mass storage 2110 collectively store an operating system, which may be any appropriate operating system to coordinate the functions of the various components shown in FIG. 18.

Additional input/output devices are shown as connected to the system bus 2102 via a display adapter 2115 and an interface adapter 2116. In one aspect, the adapters 2106, 2107, 2115, and 2116 may be connected to one or more I/O buses that are connected to the system bus 2102 via an intermediate bus bridge (not shown). A display 2119 (e.g., a screen or a display monitor) is connected to the system bus 2102 by a display adapter 2115, which may include a graphics controller to improve the performance of graphics-intensive applications and a video controller. A keyboard 2121, a mouse 2122, a speaker 2123, etc., can be interconnected to the system bus 2102 via the interface adapter 2116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 18, the computer system 2100 includes processing capability in the form of the processors 2101, and storage capability including the system memory 2103 and the mass storage 2110, input means such as the keyboard 2121 and the mouse 2122, and output capability including the speaker 2123 and the display 2119.

In some aspects, the communications adapter 2107 can transmit data using any suitable interface or protocol, such as the internet small computer system interface, among others. The network 2112 may be a cellular network, a radio network, a wide area network (WAN), a local area network (LAN), or the Internet, among others. An external computing device may connect to the computer system 2100 through network 2112. In some examples, an external computing device may be an external web server or a cloud computing node.

It is to be understood that the block diagram of FIG. 18 is not intended to indicate that the computer system 2100 is to include all of the components shown in FIG. 14. Rather, the computer system 2100 can include any appropriate fewer or additional components not illustrated in FIG. 18 (e.g., additional memory components, embedded controllers, modules, additional network interfaces, etc.). Further, the aspects described herein with respect to computer system 2100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various aspects.

It will be appreciated that aspects of the present disclosure may be embodied as a system, method, or computer program product and may take the form of a hardware aspect, a software aspect (including firmware, resident software, micro-code, etc.), or a combination thereof. Furthermore, aspects of the present disclosure may take the form of a computer program product embodied in one or more computer-readable medium(s) having computer-readable program code embodied thereon. Methods herein can be computer-implemented methods.

One or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer-readable storage medium may be a tangible medium containing or storing a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

The computer-readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer, and partly on a remote computer, or entirely on the remote computer or server.

It will be appreciated that aspects of the present disclosure are described herein with reference to flowchart illustrations and/or block diagrams of methods, apparatus (systems), and computer program products according to aspects. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

While the invention has been described in detail in connection with only a limited number of aspects, it should be readily understood that the invention is not limited to such disclosed aspects. Rather, the invention can be modified to incorporate any number of variations, alterations, substitutions, or equivalent arrangements not heretofore described but which are commensurate with the spirit and scope of the invention. Additionally, while various aspects of the invention have been described, it is to be understood that aspects of the invention may include only some of the described aspects. Accordingly, the invention is not to be seen as limited by the foregoing description but is only limited by the scope of the appended claims.

What is claimed is:

1. A mobile three-dimensional (3D) measuring system, comprising:
a 3D measuring device comprising a sensor that emits a plurality of scan lines in a field of view of the sensor;
a field of view manipulator coupled with the 3D measuring device, the field of view manipulator comprising a passive optic element that redirects a first scan line from the plurality of scan lines;
a computing system coupled with the 3D measuring device, wherein:
the 3D measuring device continuously transmits a captured data from the sensor to the computing system as the 3D measuring device is moved in an environment, the captured data is based on receiving a plurality of reflections corresponding to the plurality of scan lines, including a reflection of the first scan line that is redirected; and
the computing system generates a 3D point cloud representing the environment based on the captured data and stores the 3D point cloud.

2. The system of claim 1, wherein the 3D measuring device is a time-of-flight scanner.

3. The system of claim 2, wherein the 3D measuring device is portable.

4. The system of claim 1, wherein the sensor is a LIDAR device.

5. The system of claim 1, wherein the 3D measuring device is configured for wireless communication with the computing system.

6. The system of claim 1, wherein the computing system generates a 2D projection as live feedback of the movement of the 3D measuring device.

7. The system of claim 6, wherein the 2D projection is displayed at a first map tile level, and in response to zooming into a portion of the 2D projection, a second map tile level is displayed.

8. The system of claim 1, wherein the passive optic element is a plurality of passive optic elements.

9. The system of claim 8, wherein the plurality of passive optic elements comprises a first optic element that redirects only the first scan line and a second optic element that redirects only a second scan line.

10. The system of claim 9, wherein the first optic element redirects the first scan line at a first angle, and the second optic element redirects the second scan line at a second angle, distinct from the first angle.

11. The system of claim 8, wherein the plurality of passive optic elements comprises a first optic element that redirects a first subset of the scan lines and a second optic element that redirects a second subset of the scan lines.

12. The system of claim 11, wherein the first optic element redirects the first subset of scan lines at a first angle, and the second optic element redirects the second subset of scan lines at a second angle, distinct from the first angle.

13. The system of claim 8, wherein the plurality of passive optic elements comprises an optic element corresponding to each respective scan line emitted by the sensor.

14. The system of claim 1, wherein the first scan line that is redirected is originally directed to a carrier of the 3D measuring device, and the first scan line is redirected away from the carrier.

15. The system of claim 1, wherein the field of view manipulator redirects the first scan line in a horizontal or a vertical plane with respect to a vertical axis of the sensor.

16. The system of claim 1, wherein the passive optic element comprises a reflective surface.

17. The system of claim 1, wherein the passive optic element comprises an absorptive surface.

18. The system of claim 1, wherein the field of view manipulator is a plurality of field of view manipulators.

19. The system of claim 1, wherein the passive optic element of the field of view manipulator is adjustable to redirect the first scan line differently.

20. The system of claim 1, wherein the scan lines comprises a light pulses emitted by the sensor.
